(19) United States
(12) Patent Application Publication
(10) Pub. No.: US 2025/0379204 A1
(43) Pub. Date: Dec. 11, 2025

(54) Control of Lead Acid Paste Transference Through Use of Ultrasonics for Viscosity Regulation

(71) Applicant: TBS Engineering Ltd., Brockworth (GB)

(72) Inventors: Shep GERRISH, Pawling, NY (US); George BAREHAM, Gloucestershire (GB)

(73) Assignee: TBS Engineering Ltd., Brockworth (GB)

(21) Appl. No.: 19/232,805

(22) Filed: Jun. 9, 2025

Related U.S. Application Data
(60) Provisional application No. 63/657,786, filed on Jun. 7, 2024.
(60) Provisional application No. 63/657,787, filed on Jun. 7, 2024.
(60) Provisional application No. 63/657,789, filed on Jun. 7, 2024.

(51) Int. Cl. H01M 4/04; H01M 4/02; H01M 4/22; H01M 4/57; H01M 4/73

(52) U.S. Cl. CPC H01M 4/0404; H01M 4/0435; H01M 4/22; H01M 4/57; H01M 4/73; H01M 2004/021

(57) ABSTRACT

A paste coating system comprises a dispensing head assembly operatively connected to a coating frame, the dispensing head assembly including one or more dispensing heads configured to dispense paste (thixotropic and/or non-Newtonian) onto a grid with respect to the coating frame, and a ultrasonic transducer adjacent to the one or more dispensing heads configured to regulate viscosity of the paste such that the paste is coated onto the grid uniformly without risking material properties. The paste coating system also comprises a controller configured to automatically control operation of the dispensing head assembly and ultrasonic transducer during coating according to one or more coating profile.

### RELATED APPLICATIONS

This application claims priority to U.S. Provisional Patent Application No. 63/657,786 titled “Application of Lead Acid Active Material Paste to Punched Lead Grid via Die Cut Coater Using Ultrasonics for Viscosity Regulation” (“the '786 Application”), U.S. Provisional Patent Application No. 63/657,787 titled “Harmonic Transference of Anode and Cathode Lead Acid Paste from a Continuous Paste Mixer to a Die Cut Coater for Precision Electrode Thickness and Enhanced Battery Performance” (“the '787 Application”), U.S. Provisional Patent Application No. 63/657,789 titled “Laser-Guided and Vision-Guided Sensing System for Aligning Lead Grid and Optimizing Active Material Application During Coating Process” (“the '789 Application”), each of which was filed on Jun. 7, 2024. The content of each of the '786, '787, and '789 Applications is hereby incorporated by reference herein in its entirety.

### FIELD OF THE INVENTION

The present invention relates to the manufacturing process of lead-acid batteries and, more particularly, to the application of active material paste to a grid.

### BACKGROUND OF THE INVENTION

Lead-acid batteries are widely used for various applications, including automotive and industrial purposes, due to their reliability and cost effectiveness. Performance and durability of these batteries highly depend on the uniformity, precision, and quality (e.g., uniform layer thickness and density across each plate) of the application of active material paste to electrical lead grids. Traditional methods for transferring paste from mixers to pasters and applying active material paste via pasters can result in inconsistencies in electrode thickness and other inefficiencies, which may lead to suboptimal electrode manufacturing, battery performance, and reduced lifecycle.

Current techniques are unable to maintain a consistent viscosity of active material paste, which can lead to difficulties in application, non-uniform coatings, and the potential waste of materials. For example, it is challenging to control the flow of and dispense thixotropic materials, such as lead paste used in battery plate production, because they exhibit high resting viscosity and can be damaged by excessive shear forces or high dispensing pressures. Traditional approaches to address these issues have been to add chemical additives, heat the material, and/or mechanically stir the lead acid paste. However, these approaches often risk altering the material's electrochemical and/or physical properties. And excessive pumping pressure may cause potential de-watering of the paste, resulting in lowered porosity and compromised battery cell performance.

Accordingly, there is a need for an improved technique for reducing viscosity of thixotropic materials when dispensing such materials, ensuring that the material remains intact and essential characteristics of the material for high-quality battery performance are maintained.

### SUMMARY OF THE INVENTION

Aspects of this disclosure relate to various embodiments of a paste coating system comprises a dispensing head assembly operatively connected to a coating frame, the dispensing head assembly including one or more dispensing heads configured to dispense paste (thixotropic and/or non-Newtonian) onto a grid with respect to the coating frame, and a ultrasonic transducer adjacent to the one or more dispensing heads configured to regulate viscosity of the paste such that the paste is coated onto the grid uniformly without risking material properties. The paste coating system also comprises a controller configured to automatically control operation of the dispensing head assembly and ultrasonic transducer during coating according to one or more coating profile.

One aspects of this disclosure relate to methods for applying active material paste to a punched lead grid. The methods include preparing an active material paste with a predetermined composition. Then, the methods include positioning the punched lead grid within a coating system. Active material paste may be applied to the grid using the coating system. Finally, the methods regulate viscosity of the active material paste in real-time using an ultrasonic transducer integrated with the coating system. In some embodiments, the ultrasonic transducer comprises the ultrasonic transducer configured to emit ultrasonic waves and a controller to monitor and adjust intensity of the ultrasonic waves to maintain a desired viscosity of the active material paste. In some embodiments, the coating system ensures uniform distribution of the active material paste across a surface of the punched lead grid. In some embodiments, the active material paste comprises lead oxide, sulfuric acid, water, and additives. In some embodiments, the ultrasonic transducer continuously monitors the viscosity of the active material paste and makes real-time adjustments to maintain optimal consistency. In some embodiments, regulating viscosity of the active material paste includes regulating pressure required to move the active material paste through a dispensing orifice. In some embodiments, regulating viscosity of the active material paste includes regulating likelihood of the active material paste adhering to a wall of a dispensing orifice.

Another aspect of this disclosure relates to a system for harmonic transference of paste comprising a continuous paste mixer, a harmonic transference mechanism, and a coating system. The continuous paste mixer may be configured to generate a homogeneous mixture of lead-acid paste. The harmonic transference mechanism may include pulsation dampeners and flow control valves to ensure steady flow of the paste. The coating system may apply the paste to electrode grids with high precision. In some embodiments, the harmonic transference mechanism further comprises sensors and feedback systems to monitor and adjust the paste flow in real-time.

Yet another aspect of this disclosure relates to methods for transferring paste. The methods include mixing paste in a continuous mixer to ensure homogeneity. Then, the methods include transferring the paste to a coating system using a harmonic transference mechanism with a consistent flow. Finally, the methods include applying the paste to electrode grids with the coating system, ensuring uniform thickness and precise application.

One aspects of this disclosure relate to a system for harmonic transference of paste. The system may comprise a laser-guided sensing device to project a reference line onto a lead grid and detect deviations from a target position, a vision-guided sensing device comprising high-resolution cameras to capture real-time images of the lead grid and a coating process, and a controller configured to process data from the laser-guided sensing device and the vision-guided sensing device and generate control signals. The system may also comprise a positioning apparatus controlled by the controller to adjust a position of the lead grid and a coating system regulated by the controller to apply active material uniformly.

In some embodiments, the laser-guided sensing device comprises one or more lasers for precise positioning. In some embodiments, the vision-guided sensing device includes image processing software for real-time monitoring and analysis. In some embodiments, the positioning apparatus further includes robotic arms, actuators, or other precision movement devices for accurate alignment. In some embodiments, the coating system includes nozzles and rollers to dispense the active material. In some embodiments, the controller monitors a position and coating quality and makes real-time adjustments. In some embodiments, the system further includes one or more dispensing heads. In some embodiments, the system further includes a vibration generating device installed adjacent to the one or more dispensing heads. In some embodiments, the system further includes an ultrasonic transducer to regulate viscosity of the paste. In some embodiments, the ultrasonic transducer reduces likelihood of the active material paste adhering to a wall of one or more dispensing heads.

Another aspect of this disclosure relate to a paste coating system that comprises a dispensing head assembly secured to a coating frame, the dispensing head assembly including one or more dispensing heads configured to dispense paste onto a grid with respect to the coating frame, and a ultrasonic transducer adjacent to the one or more dispensing heads configured to regulate viscosity of the paste such that the paste is coated onto the grid uniformly without risking material properties, and a controller configured to automatically control operation of the dispensing head assembly and ultrasonic transducer during coating according to one or more coating profiles.

Yet another aspect of this disclosure relates to methods for coating paste onto a grid without risking material properties. The methods may comprise installing a paste coating system, wherein a dispensing head assembly is secured to a coating frame, the dispensing head assembly including one or more dispensing heads configured to dispense paste onto a grid with respect to the coating frame, and an ultrasonic transducer is adjacent to the one or more dispensing heads configured to regulate viscosity of the paste such that the paste is coated to the grid uniformly without risking material properties. Then, the methods may comprise determining a coating profile for coating the paste to the grid. Subsequently, the paste may be applied to the grid uniformly using the dispensing head assembly and the ultrasonic transducer. Finally, the methods may automatically control operation of the dispensing head assembly and ultrasonic transducer during coating according to one or more coating profiles. In some embodiments, the method further monitors two or more harmonic transferring member on a target parameter of a multi-parameter control system to measure an amount of the two or more harmonic transferring member.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an example paste coating system, according to one or more aspects described herein;

FIG. 2 depicts a side view of an example paste coating system, according to one or more aspects described herein;

FIG. 3 depicts a perspective view of an example coating frame of a paste coating system, according to one or more aspects described herein;

FIG. 4A depicts a perspective view of an example dispensing head assembly of a paste coating system, according to one or more aspects described herein;

FIG. 4B depict various views of an example dispensing nozzle of paste coating system, according to one or more aspects described herein;

FIGS. 4C-4D depict various views of an example dispensing nozzle of paste coating system, according to one or more aspects described herein; and

FIG. 5 depicts a flow diagram of an example method for applying active material paste to a punched lead grid utilizing a paste coating system, according to one or more aspects described herein;

FIG. 6 depicts a flow diagram of an example method for transferring paste with harmonic transferring member, according to one or more aspects described herein;

FIG. 7 depicts a flow diagram of an example method for dispensing/coating utilizing a paste coating system with harmonic transferring member, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

The present invention relates to the manufacturing process for lead-acid batteries and, more specifically, the application of active material paste to a grid (which may also be referred to as a punched lead grid). It involves a method that employs a coater (or die cut coater) and ultrasonics to regulate viscosity of active material paste for efficient and controllable application to the grids. More specifically, this invention provides a method for applying lead-acid active material paste to a grid using a coater and ultrasonics to regulate viscosity of the active material paste to allow uniform and controllable application of the active material to the grid.

Paste used in pasting plates for lead-acid batteries is a non-Newtonian fluid. This means that its viscosity can change depending on shear rate or stress applied to the paste. When mixed and manipulated, paste behaves differently compared to Newtonian fluids (e.g., water), which have a constant viscosity regardless of the applied stress. In contrast, thixotropic fluid is a type of non-Newtonian fluid that decreases in viscosity over time when subjected to a constant shear stress or agitation, and gradually returns to a more solid-like state (with higher viscosity) when left undisturbed. Lead-acid battery paste is considered a thixotropic fluid because (i) during application (when paste is being mixed, spread, or applied to the battery plates), shear stress may cause it to become more fluid (with lower viscosity), making it easier to work with, and (ii) when at rest (once the shear force is removed (e.g., after application)), the paste thickens and solidifies over time, which helps it maintain its shape on the plates before it is dried and cured.

Dispensing/coating a thixotropic paste for lead-acid batteries can be challenging due to several factors. For example, paste's initial high viscosity can make it difficult to incorporate all components evenly, requiring more force or energy to mix. From particle size point of view, dispensing/coating various ingredients (having varying particle sizes) may lead to uneven dispersion, if not mixed thoroughly. From thixotropic nature point of view, while paste becomes more fluid under shear stress, paste may quickly revert to a thicker state once dispensing stops. This may make it hard to achieve uniform consistency without continuous dispensing/coating. With respect to maintaining consistency, due to changing viscosity and time-dependent behavior of paste, it may be difficult to replicate the same consistency, especially if paste stays a certain time before is being pasted. Finally, regarding control of dispensing/coating time, as thixotropic fluids change over time, duration of dispensing/coating requires much more careful control.

In manufacturing of lead-acid batteries, uniform electrode thickness is, as always, a challenging task due to fluctuations when transferring paste from mixing to coating to lead grid substrate. Any inconsistencies may lead to performance inefficiencies, increased material setting and quality costs, and shorter battery life. This invention addresses the above problems by introducing a harmonic or ultrasonic transference system that regulate the viscosity of the non-Newtonian, thixotropic lead-acid paste as it flows from a mixer to a coater (or die cut coater). The system employs advanced controls and mechanisms to regulate the paste flow, ensuring a uniform and consistent application on the electrode grids.

According to various aspects of this disclosure, a system for facilitating the transference of non-Newtonian, thixotropic lead-acid paste with the aid of vibration is described herein. In various embodiments, an ultrasonic transducer may be used to produce a vibration that regulates the viscosity of the non-Newtonian, thixotropic lead-acid paste. In various embodiments, an ultrasonic transducer may include a high-frequency vibration source (e.g., a piezoelectric crystal transducer) operating in a range typically between 20 kHz and 100 kHz, although frequencies outside this range may be considered based on the rheological properties of the thixotropic material being dispensed.

In various embodiments, the system for facilitating the transference of non-Newtonian, thixotropic lead-acid paste with the aid of vibration may be operatively connected and used in conjunction with a continuous pasting mixer (also referred to herein as a mixer or CPM). For example, the system for facilitating the transference of non-Newtonian, thixotropic lead-acid paste may be used in conjunction with a continuous paste mixer such as that described in U.S. Provisional Patent Application Nos. 63/657,774, 63/657,776, 63/657,777, 63/657,780, 63/657,781, 63/657,784, 63/657,785, all filed Jun. 7, 2024, the content of each of which is hereby incorporated by reference herein in their entirety. In such embodiments, the continuous paste mixer may include high-shear mixing blades, temperature control, a paste viscosity sensor, and/or one or more other components or features.

In various embodiments, a paste coating system according to various aspects described herein may be integrated with various types of harmonic transferring members to transfer paste from a mixer to a paste coating system in a controlled manner. In some embodiments, a harmonic transferring member may include one or more ultrasonic transducers to allow harmonic energy to transfer to the paste to initiate and maintain flow. In some embodiments, a harmonic transferring member may include one or more pulsation dampeners to mitigate fluctuations in flow of the paste. In some embodiments, a harmonic transferring member may include flow control valves to precisely regulate amount of paste being transferred. In some embodiments, a harmonic transferring member may include one or more sensors and feedback devices to monitor paste consistency and flow rate to adjust control parameters in real-time (e.g., to maintain uniformity).

According to one aspect of this disclosure, vibration produced through the application of ultrasonics may be applied to a dispense head in targeted regions with a purpose of reducing viscosity of thixotropic fluid, thus reducing the pressure required to move the thixotropic fluid through a dispensing orifice. Another aspect of this disclosure is that, vibration produced through the application of ultrasonics may be used on thixotropic fluid in a flow path throughout a paste coating system to shear thin the thixotropic fluid at a boundary layer, reducing resistance to flow and therefore reducing pressure required to move material through its flow path. Yet another aspect of this disclosure is that vibration produced through the application of ultrasonics may be produced at inlet of a paste coating system to shear thin the thixotropic fluid at a boundary layer, reducing likelihood of thixotropic fluid sticking to (or adhering to) a wall of the inlet, as well are reducing pressure required for the thixotropic fluid to enter the inlet.

Ultrasonic frequencies are generally in a range of 20 kHz to 100 kHz, though other ranges can be used depending on material properties. In some embodiments, ultrasonic energy may be transmitted into the material near the dispensing nozzle or orifice. This ultrasonic energy may induce micro-scale shear forces in the paste, primarily at boundary and near-boundary layers, causing a temporary reduction in viscosity. Consequently, lower pressures are required for precision dosing and controlled flow. Once the ultrasonic energy is stopped, the material reverts to its higher resting viscosity, preserving dimensional stability and preventing unintended dripping or leaking.

In other words, when dispensing is initiated, the ultrasonic transducer may be energized, creating localized high-frequency vibrations at or near the nozzle exit. The ultrasonic energy induces shear thinning within the boundary layer of the paste, momentarily lowering its viscosity. This effect reduces pressure required to extrude the material and minimizes mechanical stress on the paste. For example, with respect to transducer power, ultrasonic transducers may have greater results when transducer power is higher. However, if transducer power is too high, it may result in water separation. Traditional methods for moving lead paste rely on high pressures to force the material through pipes and manifolds, often leading to undesirable effects such as the separation of water from the paste (de-watering) or damage to the material's intrinsic structure and porosity. These factors can compromise the quality and performance of the final product, especially in lead battery manufacturing. The exact ultrasonic frequency may be influenced by thixotropic fluid's characteristics (e.g., viscosity, density, temperature sensitivity) and the intended flow rate. Typical frequencies may be in a range between 20-40 kHz for coarser shear effects, while frequencies in a range between 40-100 kHz or higher may be employed for finer control in some material applications. Selection of the amplitude of the ultrasonic transducer may be made to further refine shear effect. For example, higher amplitude may create more vigorous shear thinning, suitable for highly viscous or heavily loaded materials, while lower amplitude may provide subtle viscosity modulation, reducing the risk of damaging sensitive or delicate materials.

With respect to transducer frequency, ultrasonic transducers may demonstrate best performance when frequency is at around 28 kHz. Regarding transducer location, ultrasonic transducers may may have greater results when ultrasonic transducer is as close as possible to a point of restriction such as bending points or curved area.

For another example, with respect to fluid moisture content, ultrasonic transducers may have greater results when fluid moisture content is lower. With respect to fluid density, no impact to performance of ultrasonic transducers has been identified yet. Regarding fluid volume, ultrasonic transducers may may have greater results when fluid volume is smaller.

Yet as another example, with respect to geometry, ultrasonic transducers may have greater results when resonance is to match frequency. With respect to flow path, ultrasonic transducers may have greater results when flow path is smoother. Regarding material, ultrasonic transducers may may have greater results when aluminum transducer is used. With respect to bonding, ultrasonic transducers may have greater results when layer is stiff and thin bonding layer. Adhesive or adhesive and screw. Regarding material thickness, ultrasonic transducers may may have greater results when thin material is used and below wavelength.

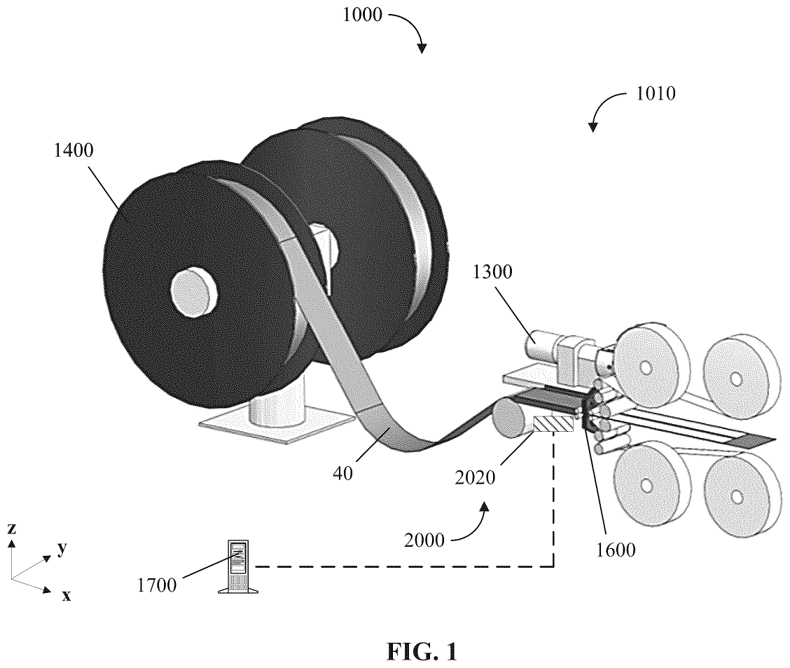

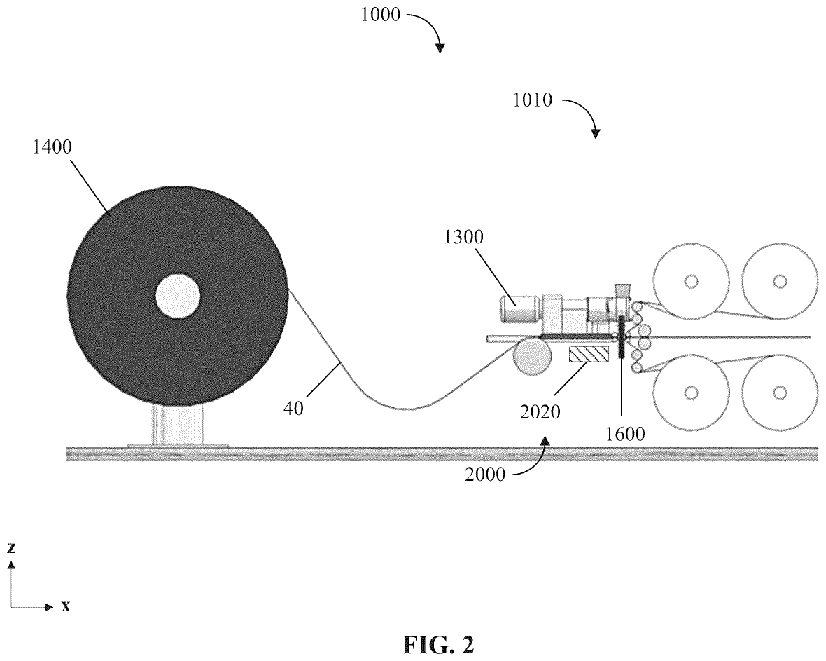

In various embodiments, a paste coating system 1000 is described herein that is configured to apply lead acid paste onto electrode grids with precision. For example, in some embodiments, paste coating system 1000 may be responsible for adjustable coating thickness settings, high-precision die cuts, and/or automated grid alignment. FIG. 1 and FIG. 2 depict various views of an example coater (which is interchangeably referred to herein as paste coating system 1000), according to one or more aspects described herein. FIG. 1 depicts a perspective view of paste coating system 1000, and FIG. 2 depicts a side view of paste coating system 1000.

As depicted in FIG. 1 and FIG. 2, paste coating system 1000 may include paste dispensing member 1010 comprising a drive member 1300, a grid feeding member 1400, a dispensing head assembly 1600, a harmonic transferring member 2000 including an ultrasonic transducer 2020, and/or one or more other components. In various embodiments, paste coating system 1000 may be configured to apply paste to a grid uniformly using dispensing head assembly along with ultrasonic transducer 2020 to regulate viscosity of the paste without risking material properties. As a result, paste coating system 1000 may generate a high-quality uniform paste consistently and repeatably.

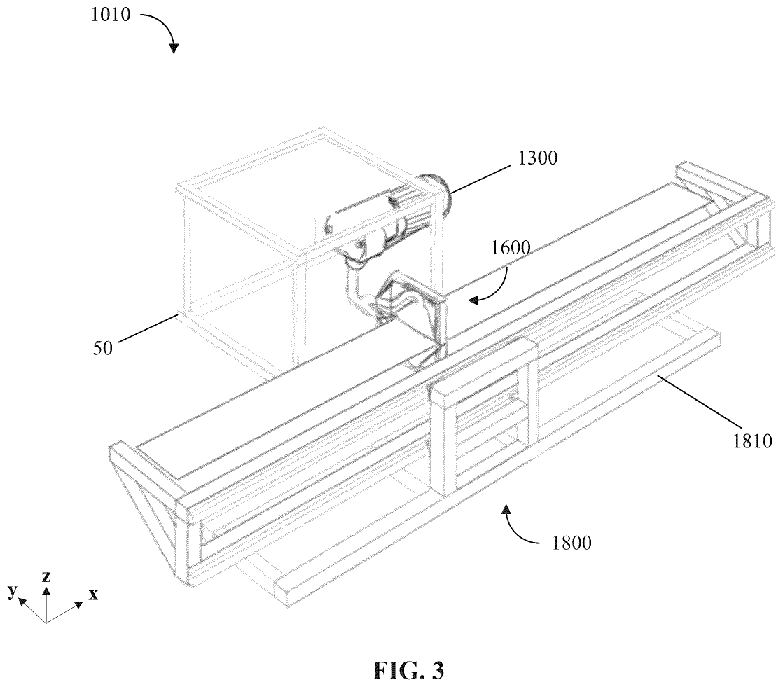

FIG. 3 depicts a perspective view of an example coating frame 1800 (or grid frame) of paste coating system 1000, according to one or more aspects described herein. As depicted in FIG. 3, in various embodiments, drive member 1300 and/or one or more other components may be installed on or attached to a frame 50, and dispensing head assembly 1600 may be positioned adjacent or otherwise in close proximity to and operatively connected to coating frame 1800 (or grid frame).

In some embodiments, paste coating system 1000 may include various test procedures. For example, paste coating system 1000 may include tooling type, grid speed, grid feed angle, masking, dispensing rate to grid feed control, and/or other test procedures to generate a high-quality uniform paste consistently and repeatably. In some embodiments, coating frame 1800 (or grid frame) may be configured to hold grid with tension. In other embodiments, coating frame 1800 (or grid frame) may include a rack, pinion, servo motor, and/or one or more other components. In some embodiments, coating frame 1800 (or grid frame) may be configured to include linear rails, bearing, and/or one or more other components to slidably move the coating frame 1800 in/out to allow grid loading precisely, consistently and repeatably.

In various embodiments, and referring back to FIG. 1, paste coating system 1000 may include a controller 1700 configured to automatically control or facilitate control of components of paste coating system 1000. In various embodiments, controller 1700 may be positioned adjacent to or otherwise in close proximity to frame 50 and a coating frame 1800 (or grid frame). For example, the controller may be configured to automatically control movement and operation of drive member 1300, grid feeding member 1400, dispensing head assembly 1600, harmonic transferring member 2000 during dispensing/coating according to one or more dispensing/coating profiles, as described further herein. In various embodiments, the controller of paste coating system 1000 may include or comprise one or more processors configured to provide information processing capabilities in paste coating system 1000. For example, the one or more processors may comprise a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. The processor(s) of the controller may be configured to execute one or more computer readable instructions. In various embodiments, the controller of paste coating system 1000 may be included within one or more components of paste coating system 1000 described herein (such as, e.g., in dispensing head assembly 1600, harmonic transferring member 2000 including ultrasonic transducer 2020, and/or one or more other components) or may be located separately and/or remotely from the one or more other components of paste coating system 1000 described herein.

In some embodiments, controller 1700 may be configured to control ultrasonic frequency, amplitude, and/or duty cycle. In other embodiments, sensor feedback (e.g., flow rate, dispense volume, or pressure readings) may be used to dynamically adjust ultrasonic parameters for optimal viscosity reduction and flow control. For example, in some embodiments, using a closed-loop control, real-time data from pressure, flow rate, or rheology sensors may automatically adjust ultrasonic parameters for optimal usability, ensuring consistent distribution and reliable production output.

In various embodiments, drive member 1300 may be configured to provide mechanical (i.e., rotatable) energy or power to grid feeding member. In various embodiments, drive member 1300 may include an electric motor, a gearbox, encoders and/or one or more other components. In some embodiments, drive member 1300 may include twin screw and a rotary piston and/or one or more other components. The components of paste coating system 1000 may be variously combined or contained within one or multiple components or the components may be separated and/or included in other components.

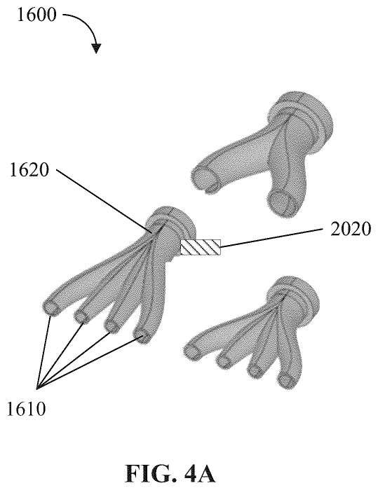

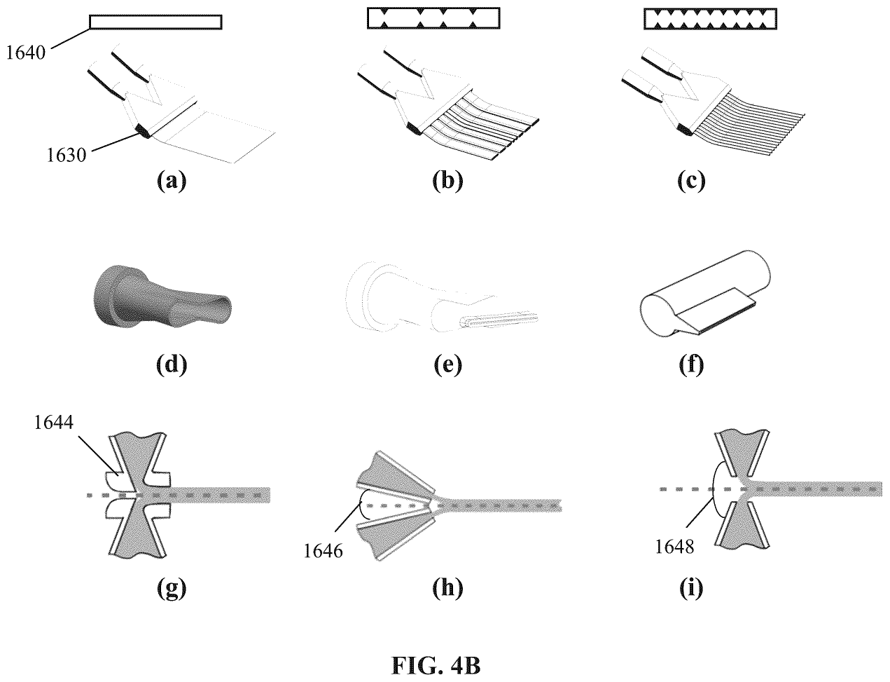

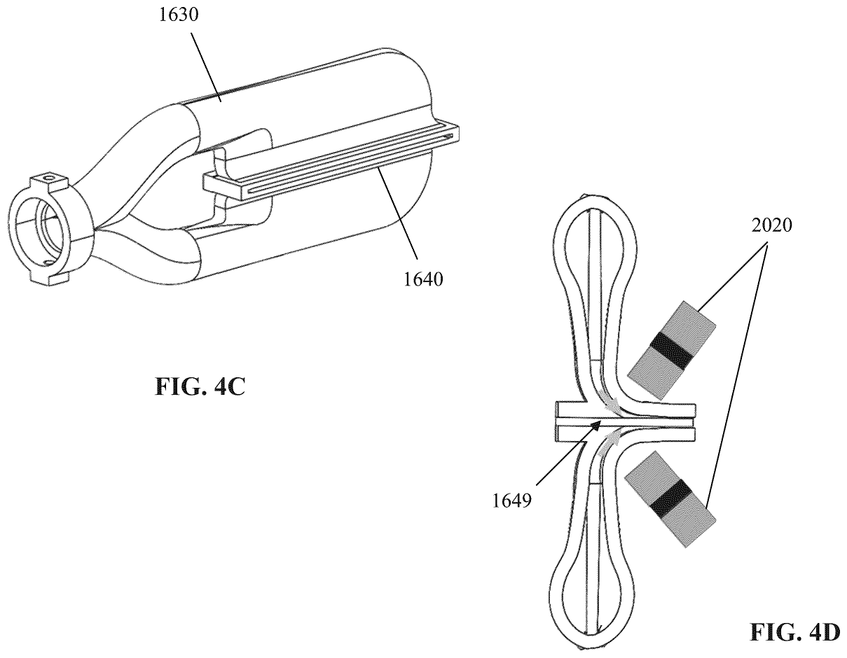

FIG. 4A depicts a perspective view of an example dispensing head assembly 1600 of a paste coating system 1000, according to one or more aspects described herein. Aspects of this disclosure relate to various embodiments of a paste coating system configured to regulate viscosity of the paste 80 such that the paste is coated onto the grid uniformly without risking material properties. In various embodiments, the controller of paste coating system 1000 may include dispensing head assembly 1600 comprising one or more dispensing heads 1610 operated with harmonic transferring member 2000 such as ultrasonic transducer 2020.

Referring back to FIG. 1B for various consideration issues to provide optimal results when ultrasonic transducers 2020 is used with paste coating system 1000, regarding fluid volume, ultrasonic transducers may may have greater results when fluid volume is smaller. As such, one or more dispensing heads 1610 may comprise one or more dispensing heads 1610 to have smaller or distributed volume than volume of incoming manifold 2010. In some embodiments, one or more dispensing heads 1610 may include extruded cylindrical shape. Regarding transducer location, ultrasonic transducers may may have greater results when ultrasonic transducer is as close as possible to a point of restriction such as bending points or curved area. Accordingly, ultrasonic transducer 2020 may be positioned adjacent or otherwise in close proximity to bending points or curved area of the one or more dispensing heads 1610. For example, ultrasonic transducer 2020 may be positioned adjacent or otherwise in close proximity to a split point 1620 showing a drastic reduction in pressure required to extrude the paste. As a result, ultrasonic transducer 2020 may be positioned adjacent or otherwise in close proximity to a split point 1620 to reduce viscosity of thixotropic materials at point of dispense, ensuring that material remains intact and maintaining essential characteristics for high-quality battery performance.

With respect to flow path, ultrasonic transducers may have greater results when flow path is smoother. One of the consideration issues is to generate a controlled flow of paste across the one or more dispensing heads 1610. Another consideration issue may be to minimize pressure requirements to dispense at maximum production speed. In various embodiments, one or more dispensing heads 1610 may be connected to controller 700 to predict (simulate) way the dispense head may perform. For example, one or more dispensing heads 1610 may be connected to controller 700 comprising CFD software and/or support data for flow path development. In some embodiments, one or more dispensing heads 1610 may be include an increased flow speed, for example, delivering paste in a speed range of around 350-400 mm/s.

FIG. 4B depict various views of example dispensing nozzles 1630 of paste coating system 1000, according to one or more aspects described herein. In some embodiments, as depicted in (a)-(c), dispensing nozzle 1630 may include a nozzle opening 1640 (or slit) with (a) a generally rectangular cross-sectional shape, (b) a generally rectangular shape with proportionally (or non-uniformly) distributed width, or (c) a generally rectangular shape with evenly (or uniformly) distributed width. In other embodiments, as depicted in (d)-(e), dispensing nozzle 1630 may include nozzle opening 1640 with (d) a generally curved shape with a wide width or (e) a generally curved shape with a narrow width. In certain embodiments, and as shown in (f), dispensing nozzle 1630 may include nozzle opening 1640 located in a designated side. In some embodiments, as depicted in (g)-(h), dispensing nozzle 1630 may include (g) a nozzle 1630 with a thickness 1644, (h) a nozzle 1630 with a generally smaller angle 1646, or (i) a nozzle 1630 with a generally larger angle 1648.

FIGS. 4C-D depict various views of an example dispensing nozzle 1630 of paste coating system 1000, according to one or more aspects described herein. For example, FIG. 4C depicts a perspective view, and FIG. 4D depicts a cross-sectional view of an example path of dispensing nozzle 1630, according to one or more aspects described herein. In various embodiments, as depicted in FIG. 4C, dispensing nozzle 1630 may include nozzle opening 1640 located in a designated side. In some embodiments, dispensing nozzle 1630 may include nozzle opening 1640 with a generally curved path in a cross-sectional view. Incoming thixotropic materials (i.e., lead paste) may be routed (or directed) through the generally curved path. In various embodiments, ultrasonic transducers 2020 may be positioned adjacent or otherwise in close proximity to a curved point 1649 to reduce viscosity of thixotropic materials at point of dispense, to ensure that material remains intact and maintaining essential characteristics for high-quality battery performance.

This invention presents a vibration-assisted system configured to reduce viscosity of thixotropic materials on boundary layer, with a primary focus on lead paste. A vibration generator, such as an unbalanced motor, piezoelectric transducer, or other mechanical oscillator, may be coupled to exterior of pipework or manifolds containing the paste. When activated, the system imparts vibrational forces that induce shear thinning in the boundary layer of the paste, allowing it to flow more freely.

By targeting reduction of viscosity in boundary layer, overall resistance to flow may be decreased, thereby reducing the pump pressure required to move lead paste through pipework and manifolds. Once vibrations cease, the paste may revert to its higher resting viscosity, ensuring stability during periods of inactivity and preserving the paste's structural and electrochemical integrity.

Once again, one aspect of this disclosure is that vibration in a form of ultrasound may be applied to dispense head in targeted regions with a purpose of reducing viscosity of thixotropic fluid, thus reducing pressure required to move the thixotropic fluid through dispensing orifice. Another aspect of this disclosure is that, vibration in a form of ultrasound may be applied to thixotropic fluid in a flow path throughout paste coating system 1000 to shear thin the thixotropic fluid at a boundary layer, reducing resistance to flow and therefore reducing pressure required to move material through its flow path. Yet another aspect of this disclosure is that vibration in a form of ultrasound may be applied to inlet of paste coating system 1000 to shear thin the thixotropic fluid at a boundary layer, reducing likelihood of thixotropic fluid sticking to (or adhering to) a wall of the inlet, as well are reducing pressure required for the thixotropic fluid to enter the inlet.

In various embodiments, dispensing nozzle 1630 of paste coating system 1000 integrated with ultrasonic transducers 2020 (i.e., vibration generator) may eliminate need for extreme pumping pressures or significant chemical manipulation, offering a straightforward method to enhance flow without compromising the material's inherent properties.

In various embodiments, paste coating system 1000 may include various integration strategies. For example, in some embodiments for a) Existing Pipelines and Manifolds, vibration units can be clamped onto or attached externally to existing pipes, manifolds, bends, or junctions, minimizing retrofitting requirements. In other embodiments, for b) Continuous or Intermittent Modes: controller may allow continuous vibration for consistent flow or intermittent pulses that only activate upon sensing higher backpressure. Sensors may relay information such as flow rate or pressure drop, enabling real-time adaptive control. In certain embodiments for c) Scale and Modularity: paste coating system 1000 may be scaled to accommodate various sizes and configurations of pipework, from small-bore laboratory lines to large industrial pipelines, including multiple vibration units spaced along the flow path.

In various embodiments, paste coating system 1000 may further include a laser-guided sensing device, a vision-guided sensing device, a positioning apparatus, and/or one or more other types of components. For example, paste coating system 1000 may be equipped with laser-guided sensing device utilizing one or more lasers to project a reference line (or point) onto the grid. The projections may be used to identify a position and/or orientation of the grid accurately. In some embodiments, laser-guided sensing device may detect (or identify) deviations from a target position (e.g., whether an axis of dispensing head assembly 1600 is oriented and generally perpendicularly aligned with an axis of the grid 40) and relay the information to a controller 1700.

In other embodiments, paste coating system 1000 may be equipped with vision-guided sensing device comprising one or more image capturing devices (or high-resolution cameras) to capture real-time images of the grid and/or coating process. In some embodiments, image processing software may analyze the images to detect misalignments, irregularities, and/or inconsistencies in coating application of the paste. For example, one or more image capturing devices may be specifically positioned at or adjacent to a dispensing head assembly 1600 to capture images of focusing only on region of interest or an area adjacent to in a direction of travel.

In various embodiments, controller 1700 may receive data from both the laser-guided and vision-guided sensing devices. In some embodiments, controller 1700 may be configured to gather data from these sensing devices and/or external sources to generate precise control signals for a positioning apparatus (or remotely located operator/system). The controller 1700 may continuously monitor a position of the grid and coating quality, and make real-time adjustments as necessary.

In various embodiments, paste coating system 1000 may receive sensed data from one or more grid control related sensors such as grid orientation sensors. In such embodiments, paste coating system 1000 may be configured to determine a status of the grid/dispensing head alignments (e.g., aligned or misaligned) by a local computing module. In alternative embodiments, paste coating system 1000 may be configured to determine a status of the grid/dispensing head alignments (e.g., aligned or misaligned) and relay the status of the grid/dispensing head alignments to control system remotely located. In various embodiments, if paste coating system 1000 determines that the grid/dispensing head alignments are not in line (or in an incorrect position), paste coating system 1000 may be configured to automatically take appropriate action to correct the position of the grid 40 and the dispensing head assembly. For example, if paste coating system 1000 determines that the grid is aiming down, paste coating system 1000 may be configured to send signals via control line to automatically increase the grid angle until it is positioned in parallel with the ground by rotating the grid 40.

In various embodiments, positioning apparatus may be controlled by controller 1700 that adjusts position of the grid based on the data from the laser-guided and vision-guided sensing devices. In some embodiments, positioning apparatus may further include robotic arms, actuators, or other precision movement devices for accurate alignment. In other embodiments, positioning apparatus may be integrated into robotic or automated assembly lines to ensure precise dispensing across large volumes of battery plates, reducing manual intervention.

In various embodiments, paste coating system 1000 may be equipped with one or more nozzles and/or rollers that dispense the paste uniformly by the controller 1700 that regulates viscosity of the paste to maintain coating application consistently and uniformly based on real-time feedback.

In operations, grid may be initially placed on the positioning apparatus. In some embodiments, laser-guided sensing device may project reference lines onto the grid. The controller 1700 may process laser data/feedback to align the grid accurately. As coating process begins, vision-guided sensing device may capture images of the grid and the applied paste. The controller 1700 may analyze the images to detect any deviations or inconsistencies. In some embodiments, positioning apparatus may make any necessary adjustments to maintain optimal alignment. For optimized coating application, controller 1700 may regulate the paste coating system 1000 to ensure coating application of the paste uniformly and consistently. Real-time adjustments may be made to address any detected issues to ensure high-quality coating.

In various embodiments, an operating system of paste coating system 1000 may include a controller configured to enable dispensing head assembly 1600 integrated with ultrasonic transducer 2020 to be controlled and/or remotely controlled.

In various embodiments, the controller may be configured to monitor two or more harmonic transferring member 2000 on a target parameter of a multi-parameter control system via one or more monitoring device, adjust valves of feeding pumps or discharging pumps, and regulate dispensing/coating parameters of dispensing head assembly 1600. For example, in some embodiments, the controller may be configured to control various aspects of dispensing head assembly 1600 or the operating system of paste coating system 1000 based on measured data acquired by one or more monitoring device. In some embodiments, using measured data acquired by one or more monitoring device, the controller may be configured to automatically adjust dispensing/coating of paste from dispensing head assembly 1600 when the amount of two or more harmonic transferring member 2000 on a target parameter of multi-parameter control system is below a threshold amount. Any appropriate controlling configuration regarding automatic and/or manual operation is contemplated and is not limited in this regard.

In some embodiments, the controller may be configured to automatically control the position of dispensing head assembly 1600 based on pre-programmed patterns, dispensing/coating modes, and/or dispensing/coating profiles (which may specify one or more pre-programmed durations and/or patterns of movement for the dispensing head assembly 1600 for dispensing/coating the paste). For example, one or more pre-programmed patterns, dispensing/coating modes, and/or dispensing/coating profiles may be stored in electronic storage accessible by the operating system of paste coating system 1000. In some embodiments, the one or more pre-programmed patterns, dispensing/coating modes, and/or dispensing/coating profiles to be used may be automatically selected based on the size of paste to apply, the shape of paste, the material stored in controller 1700, and/or one or more other factors.

In other embodiments, the one or more pre-programmed patterns or dispensing/coating modes may be automatically selected for a given dispensing head assembly 1600. In various embodiments, dispensing/coating profiles may be utilized that specify at least one pre-programmed duration and/or pattern for the dispensing head assembly 1600 for dispensing/coating the paste. For example, electronic storage accessible by the operating system of paste coating system 1000 may be configured to store one or more dispensing/coating profiles that define one or more patterns, durations, dispensing head assembly 1600 dispensing/coating modes, and/or various control parameters (e.g., frequency, amplitude, modulation type) of ultrasonic transducers 2022 (e.g., dispensing/coating ultrasonic transducers 2022 230) to be used for a given profile. In some embodiments, a user may select a given profile for a dispensing head assembly 1600. In some embodiments, the controller of paste coating system 1000 may be configured to automatically select or determine one or more pre-programmed patterns or dispensing/coating modes for a given dispensing head assembly 1600 based on knowledge of a train and/or specific paste. For example, the controller may be configured to automatically select one or more patterns, durations, dispensing/coating modes, and/or types of ultrasonic transducers 2022 based on the size, shape, and/or type of dispensing head assembly 1600, and/or one or more other factors.

In an example implementation, the dispensing/coating operation of dispensing head assembly 1600 may be programmed by the controller according to the pre-programmed pattern or dispensing/coating mode selected. For example, the dispensing/coating operation may be programmed in a horizontal configuration of the dispensing head assembly 1600. In some implementations, the pre-programmed pattern or dispensing/coating mode selected may indicate the duration of the dispensing/coating session, the amount of water and/or acid discharged into dispensing head assembly 1600, the flow rate of water and/or acid within dispensing head assembly 1600, the pressure of the water and/or acid emitted within dispensing head assembly 1600, and/or one or more other adjustable aspects of dispensing head assembly 1600.

In some embodiments, the controller may be configured to automatically determine the dispensing/coating set of profiles to direct paste to target parameter of a multi-parameter control system to remove two or more harmonic transferring member 2000 within dispensing head assembly 1600 or otherwise dispense/coat from the dispensing head assembly 1600. For example, dispensing head assembly 1600 may include one or more monitoring systems configured to learn and map the interior contours of dispensing head assembly 1600, such that one or more dispensing/coating profiles may be automatically determined by the controller. Dispensing head assembly 1600 may then be configured to direct uniformly mixed paste to remove two or more harmonic transferring member 2000 within dispensing head assembly 1600 or otherwise dispense/coat from the dispensing head assembly 1600 according to the dispensing/coating profile (or parameters) determined by the controller.

In some embodiments, paste coating system 1000 may include chaptering vibration zones. For example, multiple vibration segments along the pipe may be configured to provide targeted shear thinning at specific locations-such as elbows, junctions, or areas prone to buildup. In other embodiments, paste coating system 1000 may include combined thermal and vibration effects. For example, where mild heating is acceptable, combined heat and vibration may further optimize flow while maintaining material integrity. In certain embodiments, paste coating system 1000 may include sensor feedback loops. For example, controllers may integrate pressure transducers, flow meters, or rheometers for closed-loop feedback, automatically adjusting vibration in real time for optimal flow conditions and minimal energy usage.

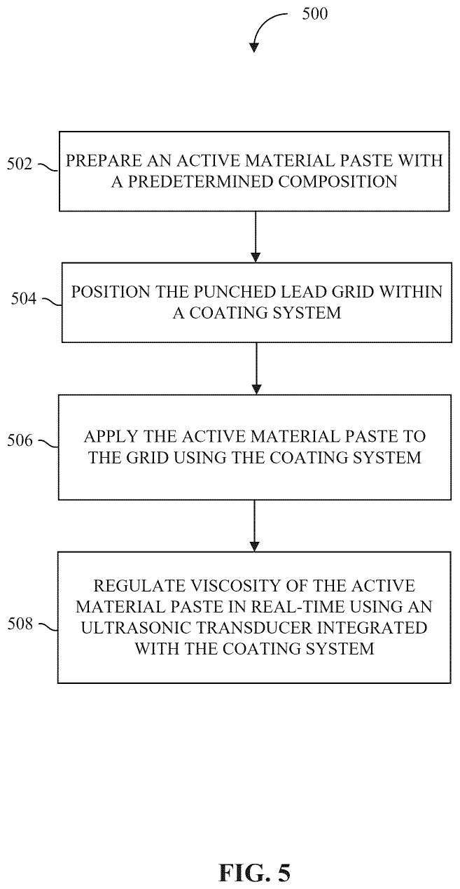

FIG. 5 illustrates an example of a process 500 for dispensing/coating utilizing paste coating system 1000, according to one or more aspects described herein. The operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components described in detail above.

In an operation 502, process 500 may include preparing a paste (or also referred as active material paste) with a predetermined composition. In various embodiments, paste may be prepared with optimal composition to ensure initial viscosity being within a controllable range. In various embodiments, paste may be loaded into a reservoir or feed line that connects to a dispenser.

In an operation 504, process 500 may include positioning a grid (or also referred as punched lead grid) within a paste coating system. In various embodiments, grid may be positioned within the paste coating system to be ready for a coating application of paste.

In an operation 506, process 500 may include applying paste to the grid using the paste coating system. In various embodiments, paste coating system may be activated to begin the coating application of paste onto the grid. The paste coating system applies the paste in a controlled manner, ensuring an even distribution across the grid.

In an operation 508, process 500 may include regulating viscosity of paste in real-time using an ultrasonic transducer 2020 integrated with the paste coating system. In various embodiments, ultrasonic transducer 2020 may be activated simultaneously with the paste coating system 1000. Ultrasonic waves may be directed at paste to regulate its viscosity to ensure paste remaining at an optimal consistency for application, preventing issues such as clumping or excessive thinning.

When dispensing is initiated, the ultrasonic transducer 2020 may be energized, creating localized high-frequency vibrations at or near the nozzle exit. The ultrasonic energy induces shear thinning within the boundary layer of the paste, momentarily lowering its viscosity. This effect reduces pressure required to extrude the material and minimizes mechanical stress on the paste.

In various embodiments, paste coating system 1000 (or automated systems) may dispense a required amount of material with high precision due to lower viscosity and reduced flow resistance.

In some embodiments, ultrasonic transducer 2020 continuously monitors the viscosity of the paste. For example, a controller 1700 to monitor and adjust the ultrasonic wave intensity in real-time to maintain the optimal viscosity, ensuring uniform application throughout the process.

Upon completion of application, entire grid may be coated with paste, the paste coating system 1000 and ultrasonic transducer 2020 may be deactivated. The coated grid is then ready for further processing, such as curing and assembly into a lead-acid battery. In other words, after dispensing, ultrasonic transducer may be switched off. The paste now recovers its original viscosity, diminishing risk of unwanted drips, material separation, or flow inconsistent with production needs.

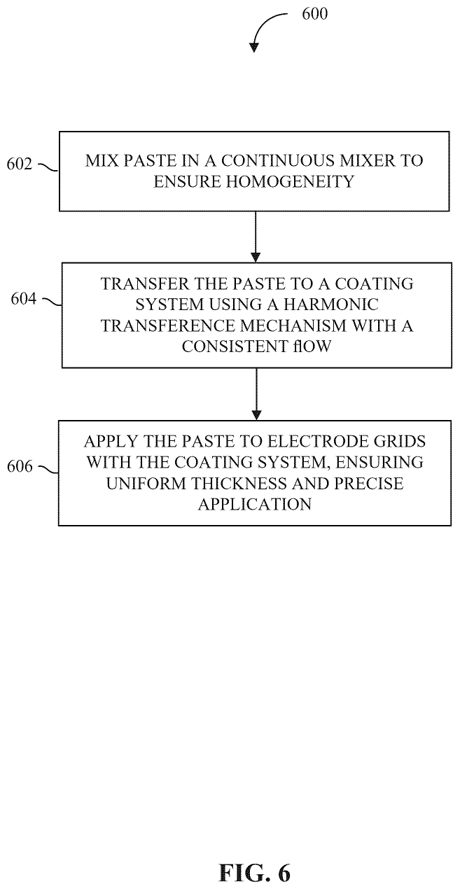

FIG. 6 illustrates an example of a process 600 for dispensing/coating two or more harmonic transferring member 2000 utilizing paste coating system 1000, according to one or more aspects described herein. The operations of process 600 presented below are intended to be illustrative and, as such, should not be viewed as limiting. In some implementations, process 600 may be accomplished with one or more additional operations not described, and/or without one or more of the operations discussed. In some implementations, two or more of the operations of process 600 may occur substantially simultaneously. The described operations may be accomplished using some or all of the system components described in detail above.

In an operation 602, process 600 may include mixing lead-acid paste in a continuous mixer to ensure homogeneity. In various embodiments, paste may be prepared with optimal composition to ensure initial viscosity being within a controllable range.

In an operation 604, process 600 may include transferring the paste to a coating system using a harmonic transference mechanism with consistent flow. In various embodiments, the paste may be transferred from a mixer to paste coating system using the harmonic transference mechanism. In some embodiments, the harmonic transference mechanism may include pulsation dampeners and flow control valves work together (or in unison) to create a steady and consistent flow of paste. In various embodiments, grid may be positioned within the paste coating system to be ready for a coating application of paste.

In an operation 606, process 600 may include applying the paste to electrode grids with the paste coating system, ensuring uniform thickness and precise application. In various embodiments, the paste coating system receives paste and applies it to electrode grids. The thickness of a paste layer may be precisely controlled, thereby ensuring uniformity across all electrodes. In addition, sensors and feedback systems may continuously monitor one or more processes. Any deviations in consistency and/or flow rate of paste may trigger automatic and real-time adjustments, to maintain any desired electrode thickness.

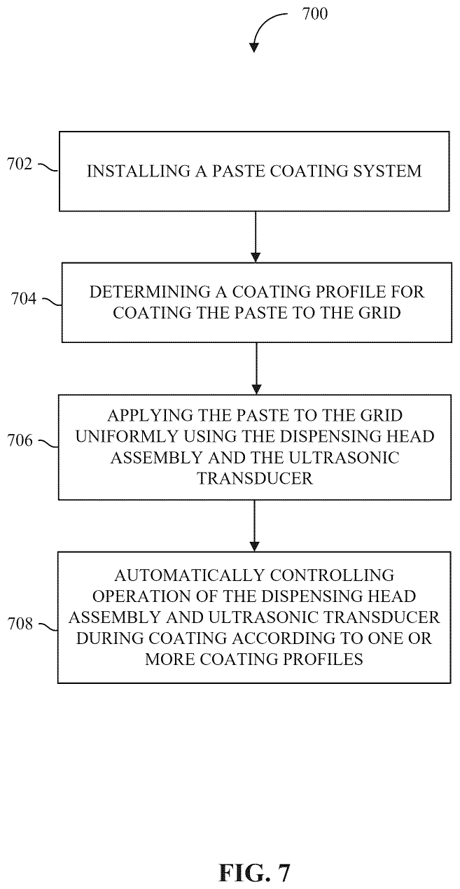

FIG. 7 illustrates an example of a process 700 for dispensing/coating utilizing a paste coating system with harmonic transferring member, according to one or more aspects described herein. The operations of process 700 presented below are intended to be illustrative and, as such, should not be viewed as limiting. In some implementations, process 700 may be accomplished with one or more additional operations not described, and/or without one or more of the operations discussed. In some implementations, two or more of the operations of process 700 may occur substantially simultaneously. The described operations may be accomplished using some or all of the system components described in detail above.

In an operation 702, process 700 may include installing a paste coating system, wherein a dispensing head assembly is secured to a coating frame, the dispensing head assembly including one or more dispensing heads configured to dispense paste (thixotropic and/or non-Newtonian) onto a grid with respect to the coating frame, and an ultrasonic transducer is adjacent to the one or more dispensing heads configured to regulate viscosity of the paste such that the paste is coated to the grid uniformly without risking material properties.

In an operation 704, process 700 may include determining a coating profile for coating the paste to the grid. In some embodiments, determining a coating profile for coating the paste to the grid may include determining one or more pre-programmed patterns or dispensing/coating modes.

In an operation 706, process 700 may include applying the paste to the grid uniformly using the dispensing head assembly and the ultrasonic transducer.

In an operation 708, process 700 may include automatically controlling operation of the dispensing head assembly and ultrasonic transducer during coating according to one or more coating profiles. In some embodiments, process 700 may further include monitoring two or more harmonic transferring member 2000 on a target parameter of a multi-parameter control system to measure an amount of the two or more harmonic transferring member 2000.

### Advantages

In various embodiments, paste coating system 1000 may have various advantages. For example, paste coating system 1000 may have improved coating application of active material paste to electrical grid uniformity consistently. 1) Enhanced efficiency: Reduces material waste and improves the efficiency of the coating process. 2) Real-Time viscosity control: Ultrasonic regulation allows for precise control over the viscosity of the paste, adapting to changes during the application process. 3) Better battery performance: Leads to more reliable and higher-performing lead-acid batteries due to the improved quality of the active material application.

From another point of view, paste coating system 1000 may have additional advantages: 4) Lower Pressure Requirement: Use of ultrasonics at the dispense head reduces the force needed to extrude lead paste, preventing damage such as de-watering or pore collapse, 5) Enhanced Flow Control: Real-time viscosity reduction at the nozzle enables precise dosing, minimizing material waste and improving the uniformity of paste application on lead grids, 6) Preservation of Paste Integrity: Since ultrasonics target the boundary layer to facilitate local shear, the core material remains largely undisturbed. The paste's electrochemical and physical properties remain intact, 7) On-Demand Viscosity Adjustment: The system can modulate ultrasonic energy levels instantly based on sensor feedback, adjusting viscosity in real time and offering greater flexibility in production rates or application patterns, 8) Retrofit Capability: The ultrasonic dispense head can be integrated into existing manufacturing lines without extensive modifications.

When using laser-guided sensing device 1810 and/or vision-guided sensing device 1820 together with grid frame 1800, paste coating system 1000 may have various advantages. For example, paste coating system 1000 may have 1) Increased Precision: The combination of laser and vision-guided sensing provides superior alignment accuracy, 2) Enhanced Consistency: Real-time monitoring and adjustments ensure uniform coating application, 3) Reduced Waste: Precise application minimizes material waste, 4) Improved Battery Performance: Optimal alignment and coating lead to better battery efficiency and lifespan, 5) Potential Modifications and Variations: The system can be adapted to various types of lead grids and active materials. Additionally, it can be integrated with existing battery manufacturing lines for seamless upgrades. Future developments may, for example, include advanced machine learning algorithms to further enhance the system's precision and adaptability.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for applying active material paste to a punched lead grid, comprising:
preparing an active material paste with a predetermined composition;
positioning the punched lead grid within a coating system;
applying the active material paste to the grid using the coating system; and
regulating viscosity of the active material paste in real-time using an ultrasonic transducer integrated with the coating system.

2. The method of claim 1, wherein the ultrasonic transducer comprises:
the ultrasonic transducer configured to emit ultrasonic waves;
a controller to monitor and adjust intensity of the ultrasonic waves to maintain a desired viscosity of the active material paste.

3. The method of claim 1, wherein the coating system ensures uniform distribution of the active material paste across a surface of the punched lead grid.

4. The method of claim 1, wherein the active material paste comprises lead oxide, sulfuric acid, water, and additives.

5. The method of claim 1, wherein the ultrasonic transducer continuously monitors the viscosity of the active material paste and makes real-time adjustments to maintain optimal consistency.

6. The method of claim 1, wherein regulating viscosity of the active material paste includes regulating pressure required to move the active material paste through a dispensing orifice.

7. The method of claim 1, wherein regulating viscosity of the active material paste includes regulating likelihood of the active material paste adhering to a wall of a dispensing orifice.

8. A system for harmonic transference of paste comprising:
a continuous paste mixer configured to generate a homogeneous mixture of lead-acid paste;
a harmonic transference mechanism that includes pulsation dampeners and flow control valves to ensure steady flow of the paste; and
a coating system that applies the paste to electrode grids with high precision.

9. The system of claim 8, wherein the harmonic transference mechanism further comprises:
sensors and feedback systems to monitor and adjust the paste flow in real-time.

10. A method for transferring paste, comprising:
mixing paste in a continuous mixer to ensure homogeneity;
transferring the paste to a coating system using a harmonic transference mechanism with a consistent flow; and
applying the paste to electrode grids with the coating system, ensuring uniform thickness and precise application.

11. A system for harmonic transference of paste comprising:
a laser-guided sensing device to project a reference line onto a lead grid and detect deviations from a target position;
a vision-guided sensing device comprising high-resolution cameras to capture real-time images of the lead grid and a coating process;
a controller configured to process data from the laser-guided sensing device and the vision-guided sensing device and generate control signals;
a positioning apparatus controlled by the controller to adjust a position of the lead grid; and
a coating system regulated by the controller to apply active material uniformly.

12. The system of claim 11, wherein the laser-guided sensing device comprises one or more lasers for precise positioning.

13. The system of claim 11, wherein the vision-guided sensing device includes image processing software for real-time monitoring and analysis.

14. The system of claim 11, wherein the positioning apparatus further includes robotic arms, actuators, or other precision movement devices for accurate alignment.

15. The system of claim 11, wherein the coating system includes nozzles and rollers to dispense the active material.

16. The system of claim 11, wherein the controller monitors a position and coating quality and makes real-time adjustments.

17. The system of claim 11, wherein the system further includes one or more dispensing heads.

18. The system of claim 11, wherein the system further includes a vibration generating device installed adjacent to the one or more dispensing heads.

19. The system of claim 11, wherein the system further includes an ultrasonic transducer to regulate viscosity of the paste.

20. The method of claim 19, wherein the ultrasonic transducer reduces likelihood of the active material paste adhering to a wall of one or more dispensing heads.

21. A paste coating system comprising:
a dispensing head assembly secured to a coating frame, the dispensing head assembly including one or more dispensing heads configured to dispense paste onto a grid with respect to the coating frame;
an ultrasonic transducer adjacent to the one or more dispensing heads configured to regulate viscosity of the paste such that the paste is coated onto the grid uniformly without risking material properties; and
a controller configured to automatically control operation of the dispensing head assembly and ultrasonic transducer during coating according to one or more coating profiles.

22. A method for coating paste onto a grid without risking material properties, the method comprising:
installing a paste coating system, wherein
a dispensing head assembly is secured to a coating frame, the dispensing head assembly including one or more dispensing heads configured to dispense paste onto a grid with respect to the coating frame; and
an ultrasonic transducer is adjacent to the one or more dispensing heads configured to regulate viscosity of the paste such that the paste is coated to the grid uniformly without risking material properties;
determining a coating profile for coating the paste to the grid;
applying the paste to the grid uniformly using the dispensing head assembly and the ultrasonic transducer; and
automatically controlling operation of the dispensing head assembly and ultrasonic transducer during coating according to one or more coating profiles.

23. The method of claim 22, further including:
monitoring two or more harmonic transferring member on a target parameter of a multi-parameter control system to measure an amount of the two or more harmonic transferring member.
